(19) United States
(12) Patent Application Publication
(10) Pub. No.: US 2016/0362897 A1
(43) Pub. Date: Dec. 15, 2016

(54) RAISED ACCESS FLOOR PANEL WITH ENHANCED RIGIDITY

(71) Applicants: Muthuraman S, Bangalore (IN); Mustufa Taiyebi Rasiwala, Mumbai (IN)

(72) Inventors: Muthuraman S, Bangalore (IN); Mustufa Taiyebi Rasiwala, Mumbai (IN)

(21) Appl. No.: 15/173,750

(22) Filed: Jun. 6, 2016

(30) Foreign Application Priority Data
Jun. 11, 2015 (IN) 2924/CHE/2015

(51) Int. Cl. E04F 15/024; B32B 3/26; B32B 7/12

(52) U.S. Cl. CPC E04F 15/02429; B32B 7/12; B32B 3/266; B32B 2471/00

(57) ABSTRACT

A raised access floor panel comprising a flat top plate and a bottom plate with wells, wherein the well region is extended towards the corner diagonally which reduces the diagonal flange length at corners of the floor panel. The top and bottom plates are sealed using a sealant and the wells of the bottom plate are then filled with a light weight adhesive mixture to enhance structural stability of the floor panel. The adhesive mixture comprises at least one of cement and concrete mixture. In one embodiment, the reduced diagonal flange length offers mechanical strength to corners of the floor panel which prevents buckling or bending of the floor panels with transportation of heavy loads on it. A series of the raised access floor panels are framed together to form an even surfaced floor structure.

### CROSS REFERENCES TO RELATED APPLICATIONS

This application claims priority from Indian patent application No. 2924/CHE/2015 filed on Jun. 11, 2015 which is incorporated herein in its entirety by reference.

### BACKGROUND

Technical Field

Embodiments of the present disclosure relate generally to floor panel and more specifically to a raised access floor panel with enhanced rigidity.

Related Art

Raised access floors are a system of panels providing an elevated floor structure above a building structural floor (for example, a concrete slab) creating a hidden void for the passage of mechanical, electrical services and utilities. These floors are helpful in ensuring quick and easy access for maintenance and upgrading the services without any disruption to the floor.

The conventional access floor panel comprises a top plate permanently fixed to a moulded/formed bottom plate providing structural efficiency. In the floor panel, the bottom plate flange and the top plate protrudes out like a cantilever. For example, the edge of the top plate comes out without a base support at edges and aligned with the adjacent plate forming a flat surface. This larger flange region gets bent or damaged forming gaps between each plate during transportation. This further reduces the stiffness and load carrying capability of the floor panel.

Later various alternate methods have been implemented to minimize the problem of formation of gaps between each plate causing deformation of the floor. However, all the alternate methods are having their own limitations. In one method, a support in the form of railings or stringers arranged in the floor panel system under the flange region of the two adjacent panels. Although this method provides a literal stability and increased support to the floor panel, it is limited to certain threshold limit of the loads and is non-durable for frequent transportation of loads as the corners remain unsupported. Also it incurs additional installation as well as maintenance costs which further require more fixing time due to complex structure of the floor panels.

Hence there is a need to provide a stable floor panel that nullifies the installation and maintenance costs as well as reducing the fixation time to a greater extent.

### SUMMARY

According to an aspect of the present disclosure, a raised access floor panel comprises a flat top plate and a bottom plate with wells, wherein the well region is extended towards the corner diagonally which reduces the diagonal flange length at corners of the floor panel. The top and bottom plates are sealed using a sealant and the wells of the bottom plate are then filled with a light weight adhesive mixture to enhance structural stability of the floor panel. In one embodiment, the top and bottom plates are sealed using welding process and the adhesive mixture comprises at least one of cement and concrete mixture.

According to another aspect of the present disclosure, the reduced diagonal flange length offers mechanical strength to corners of the floor panel which prevents buckling or bending of the floor panels with transportation of heavy loads on it. A series of the raised access floor panels are arranged together to form an even surfaced floor structure. Thus reduced diagonal flange length prevents formation of gaps between adjacent floor panels in a floor structure.

Several embodiments are described below, with reference to the diagrams for illustration. It should be understood that numerous specific details are set forth to provide a full understanding of the invention. One skilled in the relevant art, however, will readily recognize that embodiments may be practiced without one or more of the specific details, or with other methods, etc. In other instances, well-known structures or operations are not shown in detail to avoid obscuring the features of the invention.

### BRIEF DESCRIPTION OF DRAWINGS

FIGS. 1A through 1C are the block diagrams illustrating conventional access floor panel.

FIGS. 2A and 2B are the block diagrams illustrating top view of buckling corners in the conventional floor panel.

FIG. 2C is a block diagram illustrating the effect of impact load over the conventional access floor.

FIGS. 3A and 3B are the block diagrams illustrating top and bottom plates of a raised access floor panel in one embodiment of the present disclosure.

FIG. 3C is a block diagram illustrating the implementation and impact of a load on the raised access floor system in another embodiment of the present disclosure.

FIG. 4A is a block diagram illustrating top view of the effect of impact load over the raised access floor panel of the present disclosure.

FIG. 4B is a block diagram illustrating 2-D view of the effect of a rolling load over the raised access floor panel of the present disclosure.

FIGS. 5A through 5F are the schematic diagrams of the raised access floor panel in yet another embodiment of the present disclosure.

### DETAILED DESCRIPTION OF THE PREFERRED EXAMPLES

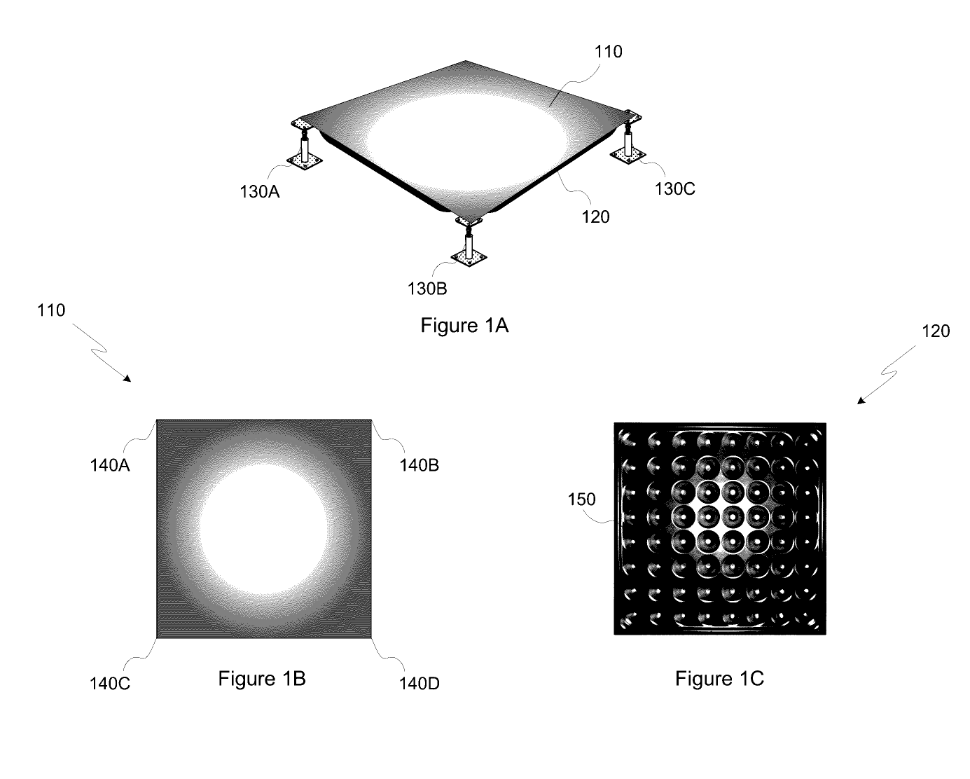

FIGS. 1A through 1C are the block diagrams illustrating conventional access floor panel. The conventional access floor comprises a series of square shaped detachable floor panel/tiles wherein each panel comprises a top plate 110 and a bottom plate 120 fixed together and mounted on at least one pedestal (130A through 130C). The pedestals are attached to the building structural floor.

As shown there, the top plate 110 and the bottom plate 120 (generally made of steel) are welded together to form a hollow shell between the two plates. The hollow shell is formed due to wells of the bottom plate as shown in FIG. 1C. These wells are further filled with a mixture of cement and additives providing a greater rigidity to the floor panel. The edge/flange of the top plate (and bottom plate) of the conventional access floor panel is sharp and protrudes out like a cantilever on all four sides as shown in FIG. 1B. Each panel is then aligned together supporting on the pedestals to form a system of uniform smooth surface of the top plates.

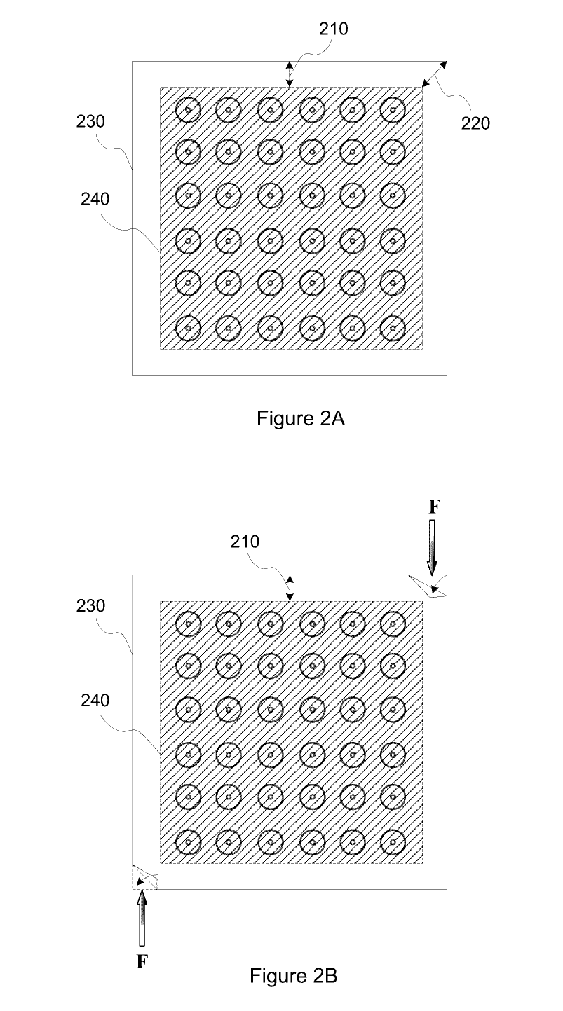

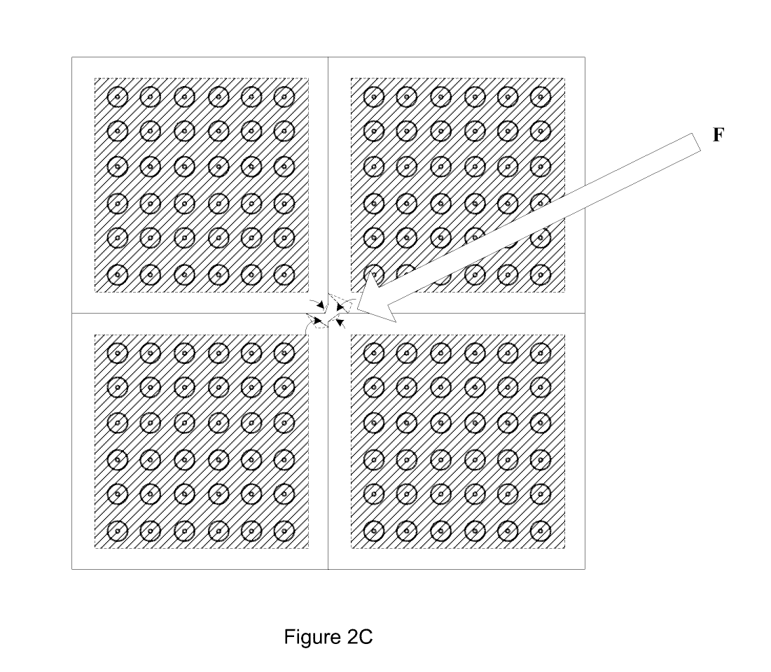

FIGS. 2A and 2B are the block diagrams illustrating top view of buckling corners in the conventional floor panel. As shown in the FIG. 2A, the cement filled portion of the bottom plate 240 is located at the middle of the top plate 230 leaving the edges of the tile (top and/or bottom plate) protrudes like a cantilever as discussed in FIG. 1B. The distance 210 from the cemented portion along the length of their sides is comparatively less than the distance 220 between cemented portion and corner of the tile. Thus the edges/corners of the tile are having a greater susceptibility to bend (impact of bending and buckling) with the movement of any load over the floor. This further illustrates that load carrying capacity of the tile is considerably greater in the middle than at its edges because of the support given by the cemented base plate. Hence the movement of any vehicle on the floor forms a buckling or bending in corner of the tile than at the middle.

FIG. 2B depicts the buckling of the flange (edge) of the access floor panel due to stress or heavy loads. The stress or heavy loads may comprise any impact or rolling loads for example, a wheeled vehicle carrying loads across/along the access floor panel. The flange protruding out like a cantilever tends to buckle as shown when a force F is applied by rolling load over the edge of the access floor panel.

FIG. 2C is a block diagram illustrating the effect of impact load over the conventional access floor. The conventional access floor system comprises a series of access panels arranged in such a way that all the top plates of each access floor panel align with the adjacent one without leaving any spaces. When the panels are laid out as a floor, certain gaps are formed between each panel due to the length of the flange of the top plate which is extending out like a cantilever. When a load is applied on the system, the weight of the rolling load over the floor deforms the access floor panel when it strikes the edges. As shown there, the application of a force F by a load makes the edges of all adjacent access floor panels get buckled out and became uneven with misalignment in the system which further makes it difficult to move anything over the floor. Also due the difference in height between the adjacent panels, the entire floor system may collapse. Due to the damages at the edges of each panel, it may generate unwanted noise, heat and further creates additional problems.

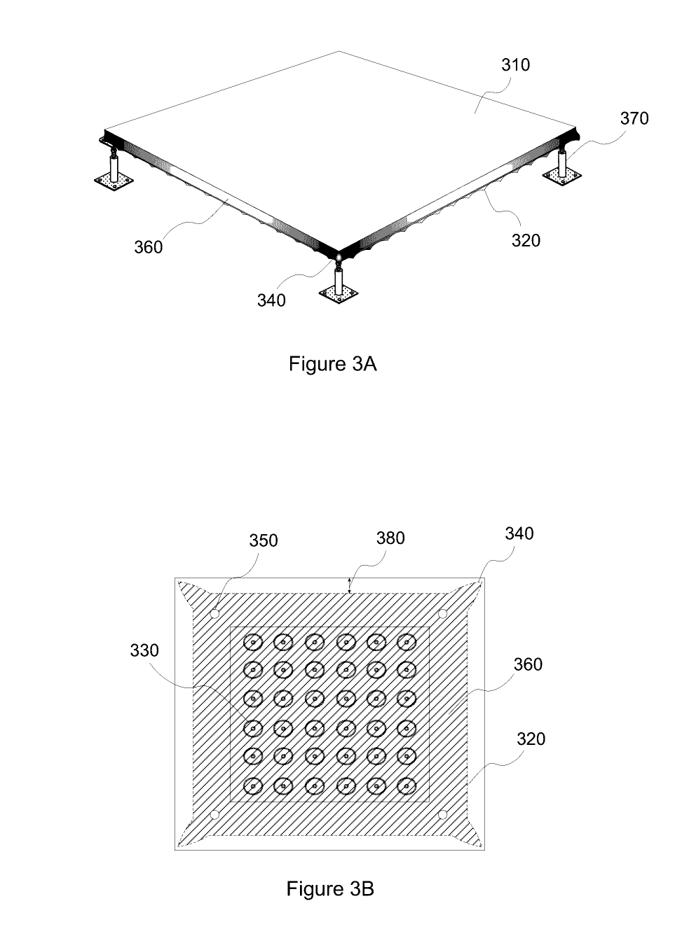

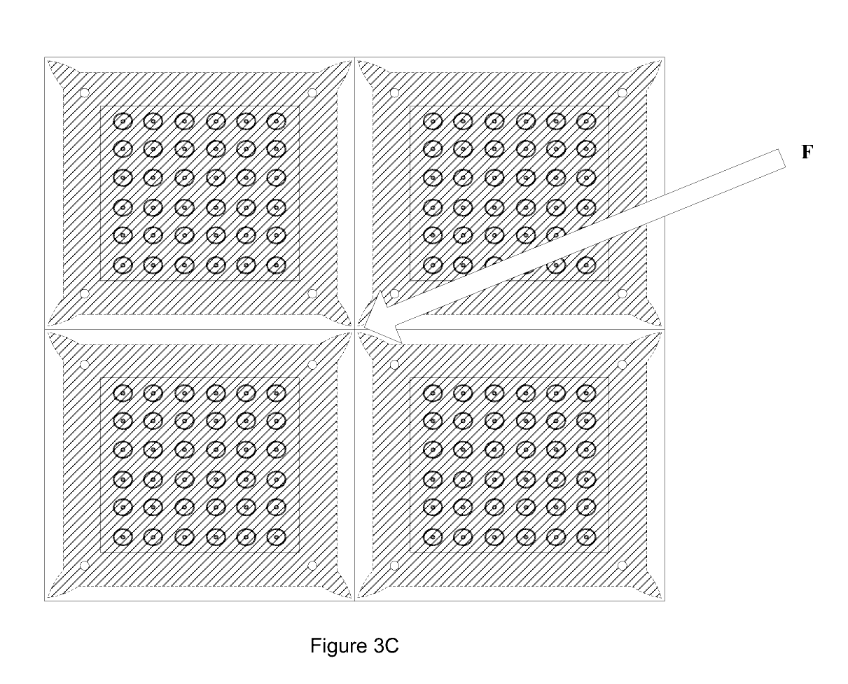

FIGS. 3A and 3B are the block diagrams illustrating top and bottom plates of a raised access floor panel in one embodiment of the present disclosure. The raised access floor panel of the present disclosure comprises a top plate 310 and a cement filled portion of the bottom plate 320 that are integrated together into a single unit by welding along their edge areas as well as each well. Welding is a conventional fabrication process that joins different materials by melting and cooling work pieces along with a filler material forming a strong joint. The top plate of the unit is a flat steel plate which is aligned with adjacent top plate forming an even surface in the raised access floor system. The top plate may comprise of any other metals and materials such as iron, aluminum, tough fibrous plastic etc. Further, the distance 380 between the adjacent sides of the bottom plate and the top plate is reduced to provide more strength and structural stability.

As shown in FIG. 3B, the bottom plate comprises a number of hollow wells 330 along with extended hollow portions at the corners of the plate. For example, the wells are hollow bulged spaces which are later filled with cement or concrete adhesive mixtures. In one embodiment, the bulged shape of the wells further reduces the amount of concrete mixture required to fill the space 360 between the top plate and bottom plate. These wells 330 are helpful in providing rigidity and stiffness which does not allow the panel to bend at its middle.

The extended portions to the corners of the bottom plate are ‘V’ shaped hollow spaces 340 provided their length to meet the corners of the top plate placed over it. After integrating the top plate and bottom plate to a single unit, the wells 330 and the extended spaces 340 are filled with a cement or concrete mixture in the space 360. The concrete mixture filled throughout the wells 330 provides structural stability at the middle whereas the mixture filled in ‘V’ shaped extended hollow spaces 340 provides structural stability across the corners of the access floor panel. Also screw holes 350 are provided to the bottom plate near the extended portions which allows fixing the screw to the pedestal 370. In one embodiment, any other mechanism of fixing may be employed to fix a screw to the pedestal. As there is no flange region which protrudes like cantilever, the buckling and bending of edges/corners in the tile is avoided.

FIG. 3C is a block diagram illustrating the implementation and impact of a load on the raised access floor system in another embodiment of the present disclosure. The raised access floor system of the present disclosure comprises a series of the access floor panels as described in the FIGS. 3A and 3B that are mounted on a number of pedestals which are attached to the building structural floor. Each access floor panel is placed together forming a flat and smooth horizontal surface over the building structural floor such that the top plates are used as the upper surface of the floor. A hollow vent is left below the raised access floor enabling easy access to certain mechanical and electrical maintenance purposes.

As shown there, each panel is fixed together without leaving any gaps between them. The hollow wells of the bottom plate filled with concrete mixture provide a greater strength to the panel on application of external force F by any load on the surface of the top plate. Also the extended portions of the bottom plate provides additional ability to withstand the force F applied by any load over the access floor panel thereby preventing buckling or bending of edges/corners in the access floor panel.

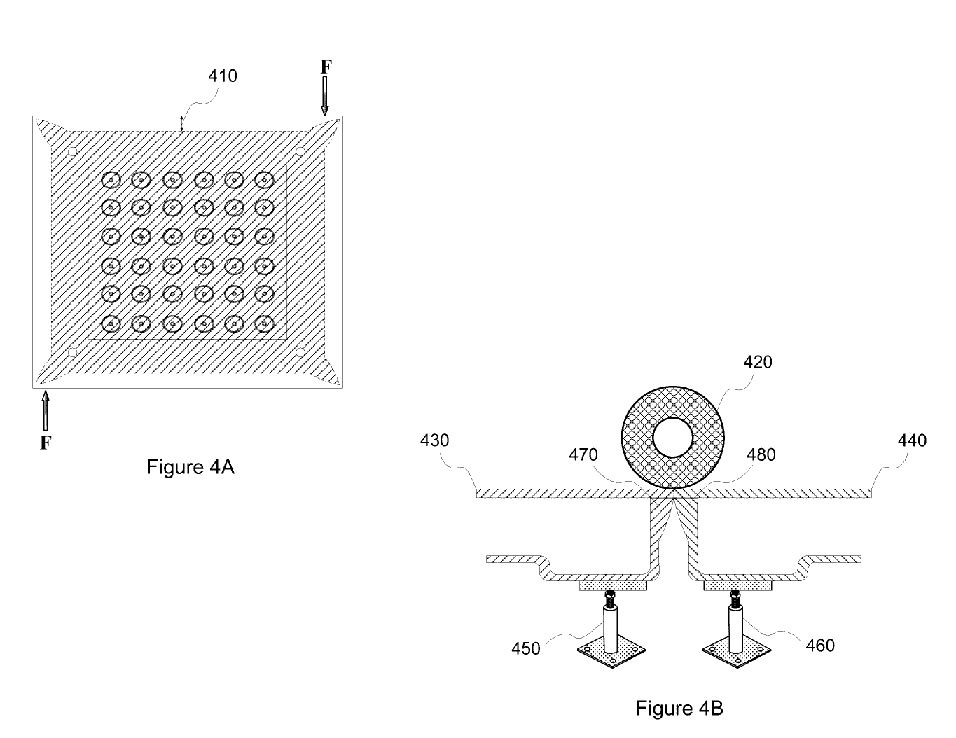

FIG. 4A is a block diagram illustrating top view of the effect of impact load over the raised access floor panel of the present disclosure. As shown there, the flange length 410 along the sides remains same and gets reduced at the corners. The reduction in diagonal flange length at corners of the access floor panel provides a good alignment prevents the buckling or bending of access floor panel at the corners.

Further, the negligible flange length of the top plate at corners of the panel offers additional support and ability to withstand the force F applied by a load across the floor. As the extended portions of the bottom plate are filled with a concrete mixture, it offers a great strength to the corners of each panel that withstand any force applied across the floor. Thus the bottom plate of the panel helps to increase the stiffness and total mechanical strength of the entire system preventing the misalignment of the floor panel from creating gaps or variations across the floor.

FIG. 4B is a block diagram illustrating 2-D view of an effect of a rolling load over the raised access floor panel of the present disclosure. As shown in the figure, a rolling load 420 is transported across the raised access floor of the present disclosure. When the rolling load strikes the edges of the floor panel, the extended portions of the bottom plate gives mechanical strength to the panel to withstand the force applied by weight of the load. As the distance or gaps from the cement filled portion of the bottom plate to the edges/corners of the tile is nullified, the buckling or bending of the panel is prevented thereby deformation of the raised access floor system is avoided.

As shown there, a rolling load 420 is striking the edges 470 and 480 of two adjacent floor panels 430 and 440 respectively. In one example, the two floor panels 430 and 440 are placed on different pedestals 450 and 460 as shown and are placed adjacent to each other without any gaps between them as described in the FIG. 3C. The weight of the rolling load acts on the both the floor panels 430 and 440 wherein the concrete support of the extended portions of the bottom plate at corners provides a mechanical strength to sustain the force without causing any buckling or bending of the top plate. Thus the negligible flange length at corners of each floor panel (tile) protects the floor system from deformation without causing any misalignment or disturbance of the floor panels.

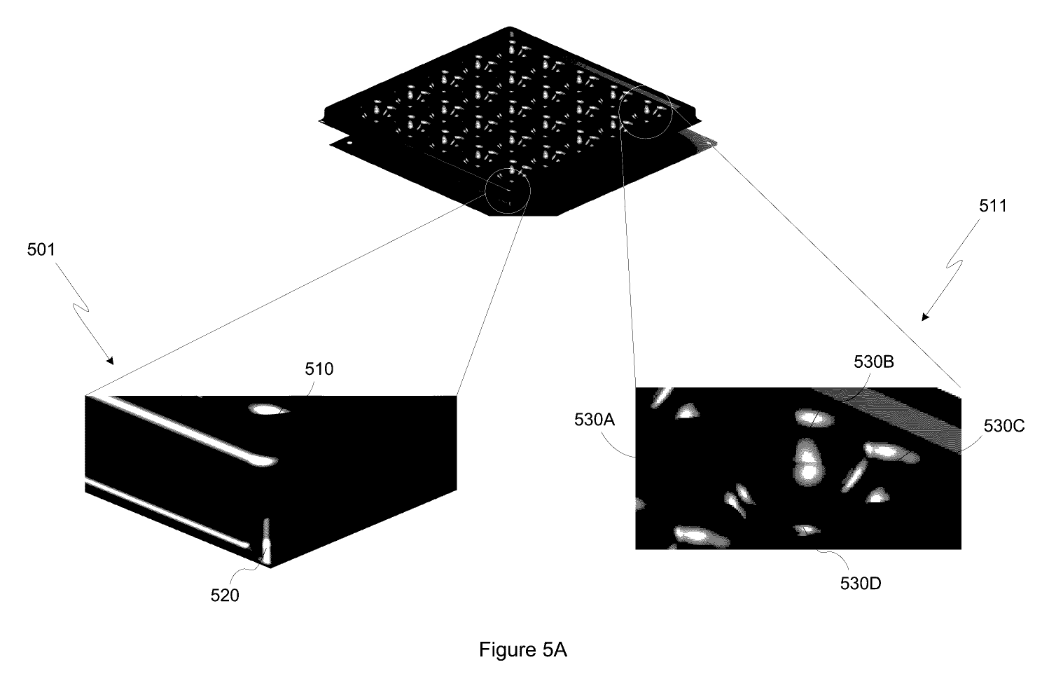

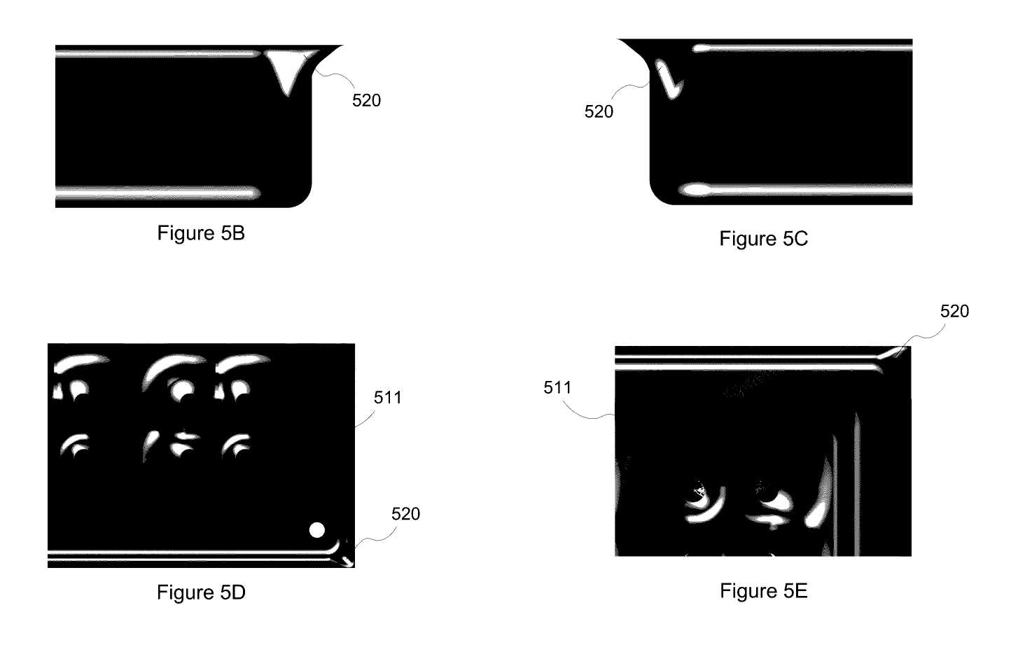

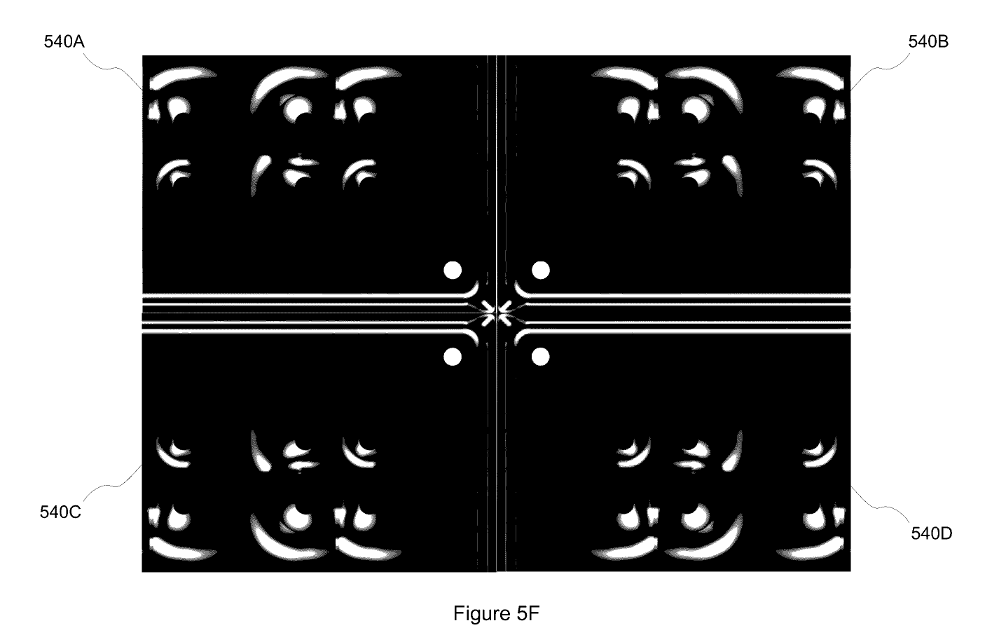

FIGS. 5A through 5F are the schematic diagrams of the raised access floor panel in yet another embodiment of the present disclosure. FIG. 5A is a schematic diagram illustrating bottom view of the raised access floor panel in one embodiment of the present disclosure. As shown there, the bottom plate has a number of cavities or wells that are facing downwards. For example, the wells with hollow spaces comes under the surface of bottom plate wherein bulged out areas (formed due to the wells) are at top of the bottom surface reducing the amount of space between the top plate and bottom plate.

As shown in 501, the corners of the raised access floor panel of the present disclosure comprises an extended region 520 that is filled with the concrete mixture along with the space between the top and bottom plates. The extended regions 520 of the bottom plate helps in nullifying the flange length of the tile at its corners where the deformation of floor panels actually start. As there is no flange length which protrude like cantilever at the corners of the tile, buckling or bending of the floor panel is prevented. This in turn protects the entire floor system without causing any disturbance in the alignment of the floor panels. Thus the extended regions nullifying the flange regions at corners offers more mechanical strength to the raised access floor of the present disclosure. Also screw holes 510 are provided to the cement filled bottom plate at its corners to fix the pedestals which are attached to the building structural floor.

As shown in 511, the cavities or wells of the bottom plate are in the shape of square pockets with four projected regions (530A through 530D) in each square pocket 511. For example, the projected regions are the areas that bulge out forming the wells under the surface of the bottom plate. The bulged regions are filled with a concrete mixture to provide a mechanical strength to the floor panel. These bulged regions are further useful in reducing the amount of concrete mixture to be filled between the top plate and the bottom plate thereby reduces the total weight of the floor panel which increases the stability and stiffness of the raised access floor.

FIGS. 5B and 5C are the schematic diagrams illustrating right view and left view of a corner of the bottom plate. Each corner of the bottom plate comprises an extended region 520 that nullifies the flange length of the tile (top and or bottom plates) in another embodiment of the present disclosure.

FIGS. 5D and 5E are the schematic diagrams illustrating top view and bottom view of the corner of a bottom plate respectively in the raised access floor panel of the present disclosure. As shown there, the corner of the bottom plate comprises the extended region 520 and at least one cavity or well in the middle of the bottom plate. In one embodiment, the cavities or wells of the bottom plate in a floor panel may vary in size, shape and number.

FIG. 5F is a schematic diagram illustrating the alignment of raised access floor panels of the present disclosure in a floor system. Each floor panel comprises a top plate and a bottom plate integrated together into a single unit. As shown in the figure, each panel is placed adjacent to one another without leaving any gaps or spaces between them. The figure illustrates the alignment of bottom plates of four adjacent access floor panels (540A through 540D), in one example. The top plates are permanently fixed to the bottom plate of each panel individually wherein the space between the top and bottom plate is filled with a concrete mixture. As shown there, the bottom plate comprising the bulged out cavities in the middle and extended hollow space at the corners are filled with a concrete mixture wherein the top plate is sealed over it. The extended region of the bottom plate helps in providing a greater strength to the raised access floor for easy transportation of any load through the edges. The wells of the bottom plate are used to provide a mechanical strength at the middle of the access floor panel.

Thus the raised access floor panel of the present disclosure offers a greater mechanical strength at the corners which further prevents the deformation of raised access floor system. Also the installation and maintenance costs along with the fixation time of these raised access floor panels is very less as there is no need of any railings or stringers to be used beneath the floor panels.

While various embodiments of the present disclosure have been described above, it should be understood that they have been presented by way of example only, and not limitation. Thus, the breadth and scope of the present disclosure should not be limited by any of the above-discussed embodiments, but should be defined only in accordance with the following claims and their equivalents.

What is claimed is:

1. A raised access floor panel comprising:
a flat top plate;
a bottom plate with wells, wherein the well region is extended towards the corner diagonally; and
a light weight adhesive mixture to fill the wells of the bottom plate,
wherein the top plate and the bottom plates are integrated to form the raised access floor panel in that the extended well region at corners of the bottom plate reduce diagonal flange length at corners of the raised access floor panel.

2. The raised access floor panel of claim 1, wherein the diagonal flange length at corners refer to the distance from corner edge of the extended well in the bottom plate to adjacent corner of the top plate.

3. The raised access floor panel of claim 1, wherein the top plate and the bottom plate comprise at least one of steel, wood core, iron, aluminium and tough fibrous plastic.

4. The raised access floor panel of claim 3, wherein the top plate and the bottom plates are integrated by welding process.

5. The raised access floor panel of claim 4, wherein the adhesive mixture comprises at least one of cement and concrete mixture providing structural stability to the floor panel.

6. The raised access floor panel of claim 5, wherein the floor panel comprises at least one aperture to fill the wells of the bottom plate after sealing the top plate and the bottom plate.

7. The raised access floor panel of claim 5, wherein the extended well regions at corners of the bottom plate further provides mechanical strength to corners of the raised access floor panel.

8. The raised access floor panel of claim 1, wherein a series of the raised access floor panels are placed adjacent to each other forming a systematic even surfaced floor structure.

9. The raised access floor panel of claim 1, wherein the raised access floor panel is mounted on at least one pedestal to provide an elevated raised access floor structure.
